(19) United States
(12) Patent Application Publication
(10) Pub. No.: US 2020/0402475 A1
(43) Pub. Date: Dec. 24, 2020

(54) DISPLAY PANEL AND DISPLAY DEVICE

(71) Applicant: BOE TECHNOLOGY GROUP CO., LTD., Beijing (CN)

(72) Inventor: Quanhu LI, Beijing (CN)

(73) Assignee: BOE Technology Group Co., Ltd., Beijing (CN)

(21) Appl. No.: 16/093,841

(22) PCT Filed: Feb. 14, 2018
(86) PCT No.: PCT/CN2018/076807

§ 371 Date: Nov. 1, 2018

(30) Foreign Application Priority Data
Apr. 25, 2017 (CN) 201710277842.5

(51) Int. Cl. G09G 3/36; G09G 3/3266

(52) U.S. Cl. CPC G09G 3/3677; G09G 2310/0286; G09G 3/3266

(57) ABSTRACT

A display panel and a display device are disclosed, the display panel includes: a plurality of pixel units arranged in an array in a display area, and a gate drive circuit arranged at least in the display area, where the gate drive circuit includes a plurality of shift register elements connected in cascade, each level of the plurality of shift register elements is connected respectively with a row of the plurality of pixel units, and each level of the plurality of shift register elements includes at least three shift register sub-circuits in the display area.

This application is a National Stage of International Application No. PCT/CN2018/076807, filed Feb. 14, 2018, which claims priority to Chinese Patent Application No. 201710277842.5, filed Apr. 25, 2017, both of which are hereby incorporated by reference in their entireties.

### FIELD

This disclosure relates to the field of display technologies, and particularly to a display panel and a display device.

### BACKGROUND

A display device generally includes a plurality of pixel units located in a display area, and a gate drive circuit and a source driver located in bezel areas in horizontal and vertical directions, where the source driver is configured to provide the plurality of pixel units with a data signal. The gate drive circuit includes a plurality of cascaded shift register elements, each of which corresponds to a row of the plurality of pixel units, and the plurality of pixel units are scanned and driven per row using the plurality of shift register elements to control the data signal to be written into the plurality of pixel units so as to display an image.

As the display technologies are developing, the size of the display device is growing constantly, and the resolution and refresh rate thereof become higher and higher. As the size of the display device is growing constantly and the resolution and refresh rate thereof become higher and higher, there is such a growing distance between the shift register elements and the respective pixel units that the pixel units are charged for a shorter valid period of time.

### SUMMARY

In view of this, embodiments of the disclosure provide a display panel and a display device in the following technical solutions.

The embodiments of the disclosure provide a display panel including: a plurality of pixel units arranged in an array in a display area, and a gate drive circuit arranged at least in the display area; wherein the gate drive circuit includes a plurality of shift register elements connected in cascade, each level of the plurality of shift register elements is connected respectively with a row of the plurality of pixel units, and each level of the plurality of shift register elements includes at least three shift register sub-circuits in the display area.

Optionally in the display panel above according to the embodiments of the disclosure, the gate drive circuit is arranged in the display area entirely.

Optionally in the display panel above according to the embodiments of the disclosure, each of the at least three shift register sub-circuits in each level of the plurality of shift register elements is connected respectively with one of the plurality of pixel units.

Optionally in the display panel above according to the embodiments of the disclosure, each of the at least three shift register sub-circuits in each level of the plurality of shift register elements has at least two types of signal output terminals, which are configured to output different gate drive signals.

Optionally in the display panel above according to the embodiments of the disclosure, each of the at least three shift register sub-circuits in each level of the plurality of shift register elements is connected respectively with at least two of the plurality of pixel units.

Optionally in the display panel above according to the embodiments of the disclosure, respective shift register sub-circuits connected with a same pixel unit are configured to output different gate drive signals.

Optionally in the display panel above according to the embodiments of the disclosure, respective shift register sub-circuits in each level of the plurality of shift register elements are connected respectively with corresponding pixel units through different scan signal lines.

Optionally in the display panel above according to the embodiments of the disclosure, respective shift register sub-circuits in each level of the plurality of shift register elements are connected respectively with corresponding pixel units through a same scan signal line.

Optionally in the display panel above according to the embodiments of the disclosure, respective shift register sub-circuits connected with a same column of the plurality of pixel units share a same set of clock signal lines.

Optionally in the display panel above according to the embodiments of the disclosure, respective shift register sub-circuits in the gate drive circuit share a same set of clock signal lines.

The embodiments of the disclosure provide a display device including the display panel above.

### BRIEF DESCRIPTION OF THE DRAWINGS

FIG. 1 is a schematic diagram of loads and a valid charging period of time in a unilateral gate drive method in the related art;

FIG. 2 is a schematic diagram of loads and a valid charging period of time in a bilateral gate drive method in the related art;

FIG. 3A is a first schematic structural diagram of a display panel according to the embodiments of the disclosure;

FIG. 3B is a schematic structural diagram of a magnified part M in a dotted line as illustrated in FIG. 3A;

FIG. 4 is a schematic diagram of loads and a valid charging period of time of a display panel according to the embodiments of the disclosure;

FIG. 5 is a schematic structural diagram of a display panel with a chip bonding structure in the related art;

FIG. 6 is a schematic structural diagram of a display panel with a gate array structure in the related art;

FIG. 7 is a second schematic structural diagram of a display panel according to the embodiments of the disclosure;

FIG. 8 to FIG. 11 are respective schematic diagrams of a correspondence relationship between shift register sub-circuits and pixel units according to the embodiments of the disclosure;

FIG. 12 and FIG. 13 are respective schematic diagrams of a connection relationship between respective shift register sub-circuits in a same level of a plurality of shift register elements according to the embodiments of the disclosure;

FIG. 14 is a schematic diagram of a plurality of scan directions in a display panel including the shift register elements as illustrated in FIG. 12, according to the embodiments of the disclosure;

FIG. 15 is a schematic diagram of a plurality of refresh rates in a display panel including the shift register elements as illustrated in FIG. 12, according to the embodiments of the disclosure; and

FIG. 16 is a schematic diagram of a zone-driven display panel in the related art.

### DETAILED DESCRIPTION OF THE EMBODIMENTS

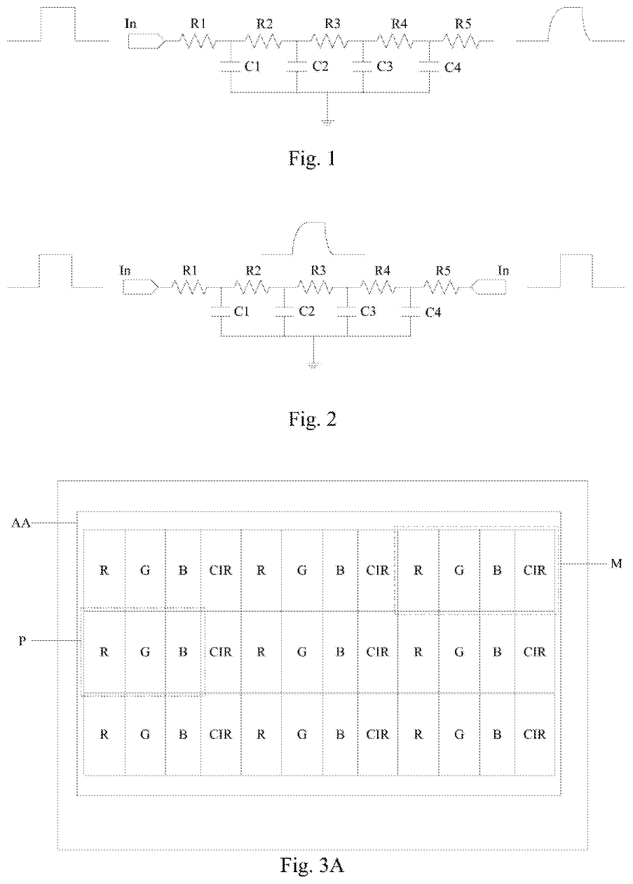

In the related art, a shift register element is generally arranged correspondingly in a bezel area on one side of a row of pixel units, that is, the pixel units are scanned via a unilateral gate drive method, as illustrated in FIG. 1. In the unilateral gate drive method, there is a lower load of the shift register element on a pixel unit at a shorter distance from the shift register element, and the pixel unit is charged for a longer valid period of time; and there is a higher load of the shift register element on a pixel unit at a longer distance from the shift register element, and the pixel unit is charged for a shorter valid period of time. As can be apparent, an output of the shift register element to the pixel unit at a longer distance from the shift register element may be affected by the higher load so that an output of the shift register element to the pixel unit at a shorter distance from the shift register element is different from the output of the shift register element to the pixel unit at a longer distance from the shift register element. In order to alleviate the difference between the loads of the shift register element on respective pixel units in the same row, it is common in the related art to arrange shift register elements on two sides of each row of pixel units respectively, that is, the pixel units are scanned via a bilateral gate drive method, as illustrated in FIG. 2. With this arrangement, there will be a shorter distance between respective pixel units in a row and the shift register elements, thus alleviating the difference in load arising from the difference between the distances between the pixel units and the shift register elements.

However as the display technologies are developing, the size of the display device is growing constantly, and the resolution and refresh rate thereof become higher and higher. As the size of the display device is growing constantly, and the resolution and refresh rate thereof become higher and higher, there is such a growing distance between a shift register element and respective pixel units that there are higher loads of the shift register element on the pixel units at a longer distance from the shift register element, so the pixel units are charged for a shorter valid period of time. At this time, neither the unilateral gate drive method nor the bilateral gate drive method can alleviate in effect the difference between the loads of the shift register element on the respective pixel units in a row of pixel units connected therewith.

In view of this, the embodiments of the disclosure provide a display panel and a display device so as to alleviate the difference between loads of a shift register element on respective pixel units in a row of pixel units connected therewith so as to prolong a valid period of time for charging the respective pixel units.

In order to make the objects, technical solutions, and advantages of the disclosure more apparent, the disclosure will be described below in further details with reference to the drawings, and apparently the embodiments to be described below are only a part but not all of the embodiments of the disclosure. Based upon the embodiments here of the disclosure, all the other embodiments which can occur to those ordinarily skilled in the art shall fall into the claimed scope of the disclosure.

The shapes and sizes of respective components in the drawings are not intended to reflect any real proportion, but only intended to illustrate the disclosure.

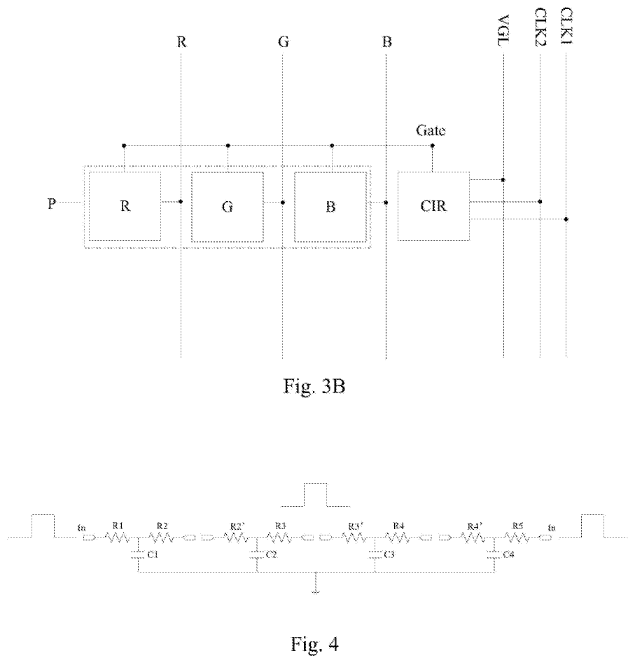

Embodiments of the disclosure provide a display panel as illustrated in FIG. 3A and FIG. 3B, which includes: a plurality of pixel units P, including red sub-pixels R, green sub-pixels G and blue sub-pixels B, arranged in an array in a display area AA, and a gate drive circuit arranged at least in the display area AA.

Where the gate drive circuit includes a plurality of shift register elements connected in cascade, each level of the plurality of shift register elements is connected respectively with a row of the plurality of pixel units, and each level of the plurality of shift register elements includes at least three shift register sub-circuits CIR in the display area AA.

In the display panel above according to the embodiments of the disclosure, each level of the plurality of shift register elements provides a gate drive signal for a row of pixel units connected therewith, and the at least three shift register sub-circuits CIR in each level of the plurality of shift register elements are arranged in the display area AA, so that the at least three shift register sub-circuits CIR in the display area AA can provide gate drive signals for respective pixel units P connected therewith in a same row of pixel units, that is, the same row of pixel units can be scanned per segment using respective shift register sub-circuits CIR. In this way, distances between respective shift register sub-circuits CIR in respective levels of shift register elements, and respective pixel units P connected therewith can be shortened to thereby lower loads of the respective shift register sub-circuits CIR on the respective pixel units P so as to alleviate the difference between the loads of the shift register element on respective pixel units P in a row of pixel units connected therewith, thus prolonging a valid period of time for charging the respective pixel units.

It shall be noted that, in the display panel above according to the embodiments of the disclosure, when the gate drive circuit is arranged in both the display area AA and a non-display area, the gate drive circuit includes a plurality of shift register elements connected in cascade, each level of the plurality of shift register elements is connected respectively with a row of pixel units, and each level of the plurality of shift register elements includes at least one or two shift register sub-circuits CIR in the display area, and two or one shift register sub-circuit CIR in the non-display area.

Further, when each level of the plurality of shift register elements includes only one shift register sub-circuit CIR in the display area AA, and two shift register sub-circuits CIR in the non-display area, optionally, in order to lower loads of respective shift register sub-circuits CIR on respective pixel units P connected therewith, the one shift register sub-circuit CIR in the display area AA is located proximate to a center axis of the display panel in a column direction, and the two shift register sub-circuits CIR in the non-display area are located on two sides of a row of pixel units corresponding thereto.

When each level of the plurality of shift register elements includes two shift register sub-circuits CIR in the display area AA, and one shift register sub-circuit CIR in the non-display area, optionally, in order to lower loads of the respective shift register sub-circuits CIR on the respective pixel units P connected therewith, the one shift register sub-circuit CIR in the non-display area is preferably located on one side of a row of pixel units corresponding thereto, and the two shift register sub-circuits CIR in the display area AA are located respectively proximate to a center axis of the display panel in a column direction, and proximate to an edge pixel unit P on the other side of the row of pixel units on which no shift register sub-circuit CIR is arranged.

Further, in the display panel above according to the embodiments of the disclosure, the respective pixel units P can be scanned via the unilateral gate drive method or the bilateral gate drive method, although the embodiments of the disclosure will not be limited thereto. Furthermore FIG. 4 illustrates a schematic diagram of loads of shift register elements on pixel units P and valid periods of times for charging the pixel units, when the respective pixel units P are scanned via the bilateral gate drive method.

As can be apparent, the loads of the shift register sub-circuits CIR located in the display area AA on the respective pixel units P are greatly lowered, and the valid periods of time for charging the respective pixel units P are prolonged, as compared with FIG. 1 where the shift register element is located in the non-display area, and the respective pixel units P are scanned via the unilateral gate drive method. As compared with FIG. 2 where the shift register elements are located in the non-display area, and the respective pixel units P are scanned via the bilateral gate drive method, the loads of the shift register sub-circuits CIR located in the display area AA on the respective pixel units P are approximate and lower, and the valid periods of time for charging the respective pixel units P are approximate and longer.

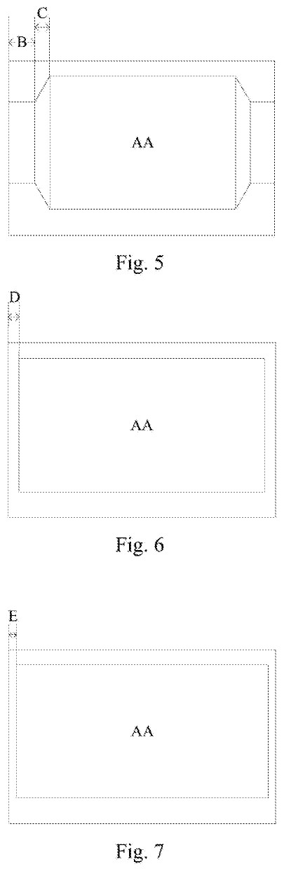

The traditional display panel shall be provided with a source integrated circuit chip and a gate integrated circuit chip to be driven, and as illustrated in FIG. 5, the traditional display panel includes a display area AA, a bonding area of the gate integrated circuit chip and a gate traveling-line area. As can be apparent, a bezel area of the traditional display panel includes the bonding area B of the gate integrated circuit chip and the gate traveling-line area C, thus making the bezel area of the traditional display panel wide.

As the display panel has a development trend of being provided with a narrow bezel and even without any bezel, the Gate on Array (GOA) technology has emerged in the market. In the GOA technology, a gate drive circuit is fabricated directly on an array substrate, and Thin Film Transistors (TFTs) in the gate drive circuit are controlled to scan and drive the display panel; and the GOA process can be performed in the same process as the pixel array substrate to thereby lower a fabrication cost. As compared with the traditional Chip on Film (COF) and Chip on Glass (COG) processes, the GOA technology can lower power consumption and improve the integration level of the display panel so as to reduce a sealing area, thus satisfying the current demand for a design of a narrow bezel. As illustrated in FIG. 6, a display panel fabricated using the GOA technology includes a display area AA, and a traveling-line area D of respective cascaded shift register elements in a gate drive circuit, where a bezel area is narrow.

In a particular implementation, in order to design a narrow bezel, in the display panel above according to the embodiments of the disclosure, the gate drive circuit (not illustrated) is arranged in the display area AA entirely as illustrated in FIG. 7. At this time, the display panel includes the display area AA and an encapsulation area EE. Since the bezel area of the display panel according to the embodiments of the disclosure includes only the encapsulation area, but not any traveling-line area or bonding area, the display panel according to the embodiments of the disclosure can be designed with a narrow bezel than the traditional display area as illustrated in FIG. 5 and the GOA-enabled display panel as illustrated in FIG. 6.

It shall be noted that when the entire gate drive circuit is arranged in the display area AA, each level of the plurality of shift register elements can include at least three shift register sub-circuits CIR or only one or two shift register sub-circuits CIR in the display area AA, although the embodiments of the disclosure will not be limited thereto. However, when each level of the plurality of shift register elements includes only one or two shift register sub-circuits CIR in the display area AA, the design of a narrow bezel can be provided but the loads of the shift register sub-circuit(s) CIR on the respective pixel units P connected therewith cannot be lowered in effect. Accordingly in a practical application, in order to provide the design of a narrow bezel and also lower the loads of the shift register sub-circuit(s) CIR on the respective pixel units P connected therewith, each level of the plurality of shift register elements preferably includes at least three shift register sub-circuits CIR in the display area AA.

In order to better understand the display panel according to the embodiments of the disclosure, for example, the entire gate drive circuit will be arranged in the display area AA, and each level of the plurality of shift register elements will include at least three shift register sub-circuits CIR in the display area AA, as described below.

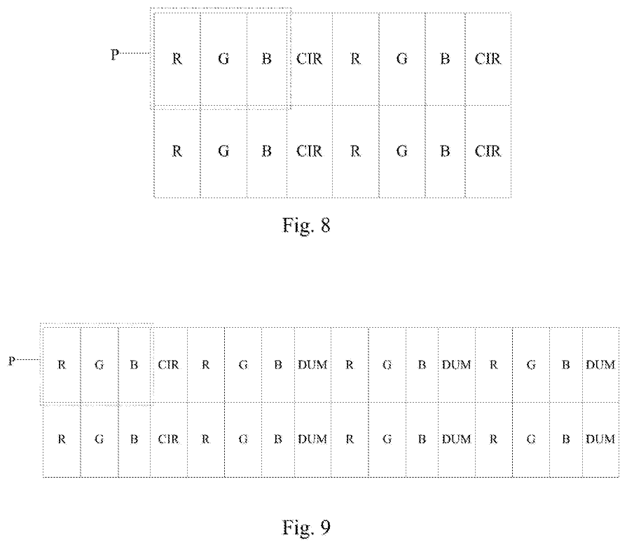

In a particular implementation, in the display panel above according to the embodiments of the disclosure, the respective shift register sub-circuits CIR in each level of the plurality of shift register elements can be connected with the pixel units P in a number of connection relationships. As illustrated in FIG. 8, for example, each shift register sub-circuit CIR in each level of the plurality of shift register elements is connected respectively with one pixel unit P; and in another example, each shift register sub-circuit CIR in each level of the plurality of shift register elements is connected respectively with several (at least two) pixel units P, although the embodiments of the disclosure will not be limited thereto. Further, as illustrated in FIG. 9, each shift register sub-circuit CIR in each level of the plurality of shift register elements is connected respectively with four pixel units P, and at this time, an area where a dummy unit DUM is arranged is configured as a pixel light-emitting area or a traveling-line area, although the embodiments of the disclosure will not be limited thereto.

Particularly the display panel above according to the embodiments of the disclosure is a liquid crystal display panel or an organic light-emitting diode display panel; or can alternatively be another active matrix display panel, although the embodiments of the disclosure will not be limited thereto.

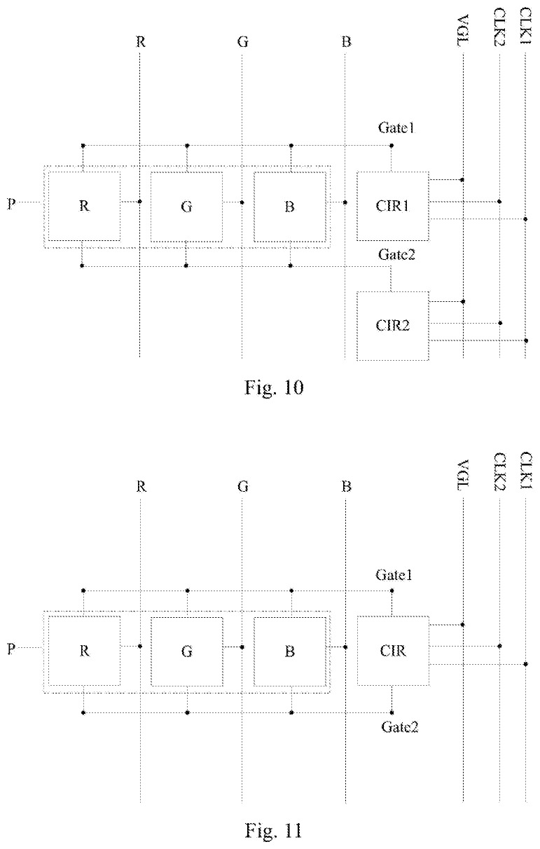

Generally, there is only one gate drive signal required of a row of pixel units in a general liquid crystal display panel, but there may be two or more gate drive signals required of a row of pixel units in some special liquid crystal display panel or in an organic light-emitting diode display panel, so respective pixel units P in the display panel above according to the embodiments of the disclosure shall be connected respectively with at least two shift register sub-circuits CIR, and respective shift register sub-circuits CIR connected with the same pixel unit P are configured to output different gate drive signals. FIG. 10 illustrates a schematic diagram of a correspondence relationship between a pixel unit P for which two gate drive signals are required, and two shift register sub-circuits CIR1 and CIR2. Where the two shift register sub-circuits CIR1 and CIR2 provide respective gate drive signals as required to the pixel unit P via scan signal lines Gate1 and Gate2 respectively.

Particularly, a shift register sub-circuit CIR can output one type of gate drive signal, or at least two types of gate drive signals. In the case that a shift register sub-circuit CIR outputs at least two types of gate drive signals, in the display panel above according to the embodiments of the disclosure, each pixel unit P can be connected respectively with one of the plurality of shift register sub-circuits CIR; and each shift register sub-circuit CIR has at least two types of signal output terminals, each of which is configured to output a different gate drive signal from the other types of signal output terminals. As illustrated in FIG. 11, a pixel unit P is connected with a shift register sub-circuit CIR, and two types of signal output terminals of the shift register sub-circuit CIR output different gate drive signals to the pixel unit P respectively via scan signal lines Gate1 and Gate2.

It shall be noted that, in the case that a shift register sub-circuit CIR outputs at least two types of gate drive signals, the shift register sub-circuit CIR can be further connected with different pixel units P. For example, a signal output terminal of the shift register sub-circuit CIR can be connected with a pixel unit through the scan signal line Gate1, and another signal output terminal thereof can be connected with any other pixel unit P through the scan signal line Gate2.

Generally, in the display panel above according to the embodiments of the disclosure, each shift register sub-circuit CIR has a signal input terminal, a signal output terminal, a voltage input terminal, a clock signal input terminal and a reset terminal; and the output terminal of each shift register sub-circuit CIR is coupled respectively with a corresponding scan signal line. A shift register element can output gate drive signals to corresponding scan signal lines respectively through respective shift register sub-circuits CIR thereof according to a clock signal.

Particularly, in order to enable a clock signal to be input into respective shift register sub-circuits CIR, in the display panel above according to the embodiments of the disclosure, respective shift register sub-circuits CIR connected with the same column of pixel units share the same set of clock signal lines. Furthermore as illustrated in FIG. 10 and FIG. 11, respective clock signal lines CLK1 and CLK2 in the same set of clock signal lines can output different clock signals respectively to the shift register sub-circuits CIR.

Optionally, in the display panel above according to the embodiments of the disclosure, respective shift register sub-circuits CIR in the gate drive circuit share the same set of clock signal lines, so that clock signals are transmitted among the respective shift register sub-circuits CIR.

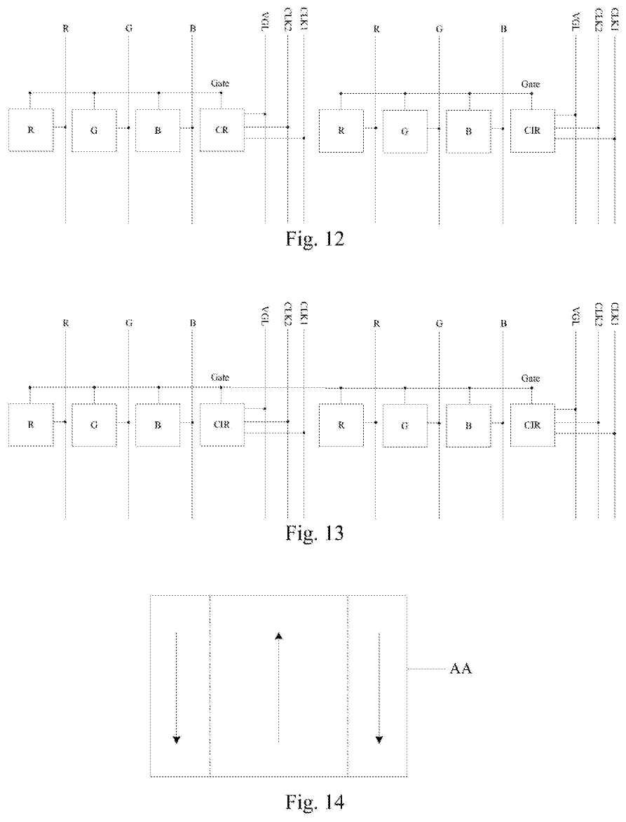

In a particular implementation, in the display panel above according to the embodiments of the disclosure, the respective shift register sub-circuits CIR in the same level of the plurality of shift register elements can be connected in a number of connection relationships, and as illustrated in FIG. 12, for example, the respective shift register sub-circuits CIR in each level of the plurality of shift register elements are connected respectively with corresponding pixel units P through different scan signal lines Gate. Optionally, the respective shift register sub-circuits CIR in each level of the plurality of shift register elements are connected with corresponding pixel units P through different scan signal lines Gate on the same straight line. As illustrated in FIG. 13, in another example, the respective shift register sub-circuits CIR in the same level of the plurality of shift register elements can alternatively be connected with corresponding pixel units P through the same scan signal line Gate. Of course, alternatively only a part of the respective shift register sub-circuits CIR in the same level of the plurality of shift register elements can be connected with corresponding pixel units through different scan signal lines Gate, and the other part thereof can be connected with corresponding pixel units P through the same scan signal line Gate, although the embodiments of the disclosure will not be limited thereto.

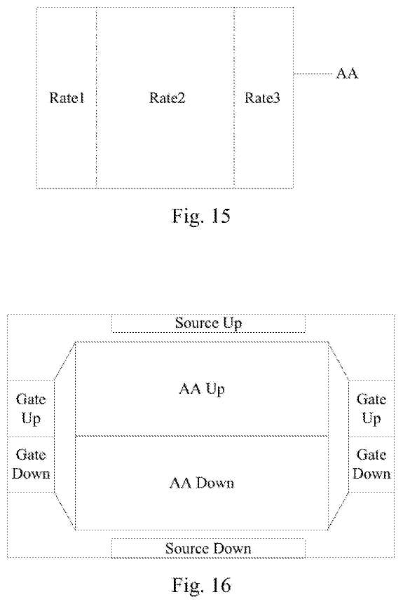

It shall be noted that, when the respective shift register sub-circuits CIR in the same level of the plurality of shift register elements are connected with corresponding pixel units through different scan signal lines Gate, different scan directions (as denoted by arrows in FIG. 14) and refresh rates (as denoted by Rate1, Rate2, and Rate3 in FIG. 15) can be provided at different positions in the display area AA by controlling scan directions and scan frequencies of the shift register sub-circuits CIR at the different positions in the display area AA.

In order to drive in effect the display panel, a zone-drive method has been proposed, and in this zone-drive method, the display area is divided into several zones to be driven. As illustrated in FIG. 16, for example, the display panel is physically divided into upper and lower halves of the display panel to be driven. Particularly, the display area AA is divided into two upper and lower display zones AA Up and AA Down, and the respective display zones are provided with control signals respectively through corresponding source drivers Source Up and Source Down, and gate drive circuits Gate Up and Gate Down, so that the display zones are controlled and driven respectively. This zone-drive method can greatly prolong a valid period of time for charging a pixel unit. Accordingly in order to further prolong a valid period of time for charging a pixel unit, the display panel above according to the embodiments of the disclosure can be driven in effect using the zone-drive method.

Of course, the display panel above according to the embodiments of the disclosure can alternatively be driven using a common drive method, where the data driver converts the input time sequence latches of display data and clock signals into analog signals, and then output the analog signals to data lines of the display panel; and the gate drive circuit converts the input clock signals into on/off voltage through the shift register elements, applies the voltage to the scan signal lines of the display panel sequentially, and scans the respective pixel units per row to display an image.

Based upon the same inventive concept, the embodiments of the disclosure further provide a display device including the display panel above according to the embodiments of the disclosure. The display device can be a mobile phone, a tablet computer, a TV set, a display, a notebook computer, a digital photo frame, a navigator, a personal digital assistant or any other product or component with a display function. Reference can be made to the embodiments of the display panel above for an implementation of the display device, and a repeated description thereof will be omitted.

The embodiments of the disclosure provide the display panel and the display device above, and the display panel includes: a plurality of pixel units arranged in an array in a display area, and a gate drive circuit arranged at least in the display area; where the gate drive circuit includes a plurality of shift register elements connected in cascade, each level of the plurality of shift register elements is connected respectively with a row of the plurality of pixel units, and each level of the plurality of shift register elements includes at least three shift register sub-circuits in the display area. Each level of the plurality of shift register elements provides a gate drive signal for a row of the plurality of pixel units connected therewith, and the at least three shift register sub-circuits in each level of the plurality of shift register elements are arranged in the display area, so that the at least three shift register sub-circuits in the display area can provide gate drive signals for respective pixel units connected therewith in the same row of the plurality of pixel units, that is, the same row of the plurality of pixel units can be scanned per segment using the respective shift register sub-circuits. In this way, the distances between the respective shift register sub-circuits in the respective levels of the plurality of shift register elements, and the respective pixel units connected therewith can be shortened to thereby lower loads of the respective shift register sub-circuits on the respective pixel units so as to alleviate the difference between the loads of the shift register elements on the respective pixel units in a row of the plurality of pixel units connected therewith, thus prolonging a valid period of time for charging the respective pixel units.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. A display panel, comprising: a plurality of pixel units arranged in an array in a display area, and a gate drive circuit arranged at least in the display area, wherein:
the gate drive circuit comprises a plurality of shift register elements connected in cascade, each level of the plurality of shift register elements is connected respectively with a row of the plurality of pixel units, and each level of the plurality of shift register elements comprises at least one shift register sub-circuit in the display area.

2. The display panel according to claim 1, wherein the gate drive circuit is arranged in the display area entirely.

3. The display panel according to claim 1, wherein each of the at least one shift register sub-circuit in each level of the plurality of shift register elements is connected respectively with one of the plurality of pixel units.

4. The display panel according to claim 3, wherein each of the at least one shift register sub-circuit in each level of the plurality of shift register elements has at least two types of signal output terminals, which are configured to output different gate drive signals.

5. The display panel according to claim 1, wherein each of the at least one shift register sub-circuit in each level of the plurality of shift register elements is connected respectively with two of the plurality of pixel units.

6. The display panel according to claim 5, wherein respective shift register sub-circuits connected with a same pixel unit are configured to output different gate drive signals.

7. The display panel according to claim 3, wherein respective shift register sub-circuits in each level of the plurality of shift register elements are connected respectively with corresponding pixel units through different scan signal lines.

8. The display panel according to claim 3, wherein respective shift register sub-circuits in each level of the plurality of shift register elements are connected respectively with corresponding pixel units through a same scan signal line.

9. The display panel according to claim 3, wherein respective shift register sub-circuits connected with a same column of the plurality of pixel units share a same set of clock signal lines.

10. The display panel according to claim 9, wherein respective shift register sub-circuits in the gate drive circuit share a same set of clock signal lines.

11. A display device, comprising a display panel; wherein the display panel comprises: a plurality of pixel units arranged in an array in a display area, and a gate drive circuit arranged at least in the display area, wherein:
the gate drive circuit comprises a plurality of shift register elements connected in cascade, each level of the plurality of shift register elements is connected respectively with a row of the plurality of pixel units, and each level of the plurality of shift register elements comprises at least one shift register sub-circuit in the display area.

12. The display device according to claim 11, wherein the gate drive circuit is arranged in the display area entirely.

13. The display device according to claim 11, wherein each of the at least one shift register sub-circuit in each level of the plurality of shift register elements is connected respectively with one of the plurality of pixel units.

14. The display device according to claim 13, wherein each of the at least one shift register sub-circuit in each level of the plurality of shift register elements has at least two types of signal output terminals, which are configured to output different gate drive signals.

15. The display device according to claim 11, wherein each of the at least one shift register sub-circuit in each level of the plurality of shift register elements is connected respectively with two of the plurality of pixel units.

16. The display device according to claim 15, wherein respective shift register sub-circuits connected with a same pixel unit are configured to output different gate drive signals.

17. The display device according to claim 13, wherein respective shift register sub-circuits in each level of the plurality of shift register elements are connected respectively with corresponding pixel units through different scan signal lines or through a same scan signal line.

18. The display device according to claim 13, wherein respective shift register sub-circuits connected with a same column of the plurality of pixel units share a same set of clock signal lines; or
respective shift register sub-circuits in the gate drive circuit share a same set of clock signal lines.

19. The display device according to claim 11, wherein each level of the plurality of shift register elements comprises at least three shift register sub-circuits in the display area.

20. The display panel according to claim 1, wherein each level of the plurality of shift register elements comprises at least three shift register sub-circuits in the display area.
